(19) United States
(12) Patent Application Publication
(10) Pub. No.: US 2025/0363764 A1
(43) Pub. Date: Nov. 27, 2025

(54) IMAGE PROCESSING APPARATUS, IMAGE PROCESSING METHOD, AND NON-TRANSITORY COMPUTER-READABLE MEDIUM

(71) Applicant: NEC Corporation, Tokyo (JP)

(72) Inventor: Manabu NAKANOYA, Tokyo (JP)

(73) Assignee: NEC Corporation, Tokyo (JP)

(21) Appl. No.: 19/203,519

(22) Filed: May 9, 2025

(30) Foreign Application Priority Data
May 21, 2024 (JP) 2024-082830

(51) Int. Cl. G06V 10/24; G06V 10/26; G06V 10/44

(52) U.S. Cl. CPC G06V 10/245; G06V 10/26; G06V 10/44

(57) ABSTRACT

For maintaining precision in processing of generating information relating to an object by using point cloud data, an image processing apparatus includes a data acquisition unit, a feature value computation unit, and an area correction unit. The data acquisition unit acquires point cloud data generated by scanning a space to be measured. The feature value computation unit sets a plurality of partial areas with a first boundary of a processing target area in the point cloud data as a reference, and computes a feature value for each of the plurality of partial areas. The area correction unit corrects the processing target area by setting a new second boundary, based on a position of a partial area satisfying a reference relating to the feature value.

This application is based upon and claims the benefit of priority from Japanese patent application No. 2024-082830, filed on May 21, 2024, the disclosure of which is incorporated herein its entirety by reference.

### BACKGROUND

### Technical Field

The present invention relates to an image processing apparatus, an image processing method, and a non-transitory computer-readable medium storing a program thereof.

### Background Art

Japanese Patent Application Publication (Translation of PCT Application) No. 2023-525538 discloses an approach to determine an estimated volume of an object captured by a 3D point cloud. The approach in Japanese Patent Application Publication No. 2023-525538 includes, for example, following processes of (1) to (3).
(1) A 3D point cloud including a plurality of 3D points and a reference plane in spatial relation to the 3D point cloud are received.
(2) For each 2D bin with a length and a width extending along the reference plane, the number of 3D points in each bin and a height of the bin from the reference plane are determined.
(3) An estimated volume of an object captured by the 3D point cloud is determined based on the number of 3D points in each bin and the height of each bin.

### SUMMARY

In a technique for generating information relating to an object (for example, an estimated volume of an object as exemplified in Japanese Patent Application Publication No. 2023-525538, or the like) based on point cloud data, lack of a point cloud indicating an important feature in relation to the object from a processing target area may reduce precision in processing thereof. A technique for maintaining precision in processing of generating information relating to an object by using point cloud data is desired.

In one example aspect of the invention, there is provided an image processing apparatus according to the present disclosure, the apparatus including:
at least one memory configured to store instructions; and
at least one processor configured to execute the instructions to perform operations including:
acquiring point cloud data generated by scanning a space to be measured;
setting a plurality of partial areas with a first boundary of a processing target area in the point cloud data as a reference;
computing a feature value for each of the plurality of partial areas; and
correcting the processing target area by setting a new second boundary, based on a position of a partial area satisfying a reference relating to the feature value.

In another example aspect of the invention, there is provided an image processing method according to the present disclosure, the method including:
by a computer:
acquiring point cloud data generated by scanning a space to be measured;
setting a plurality of partial areas with a first boundary of a processing target area in the point cloud data as a reference;
computing a feature value for each of the plurality of partial areas; and
correcting the processing target area by setting a new second boundary, based on a position of a partial area satisfying a reference relating to the feature value.

In still another example aspect of the invention, there is provided a non-transitory computer-readable medium storing a program according to the present disclosure, the program causing a computer to perform operations comprising:
acquiring point cloud data generated by scanning a space to be measured;
setting a plurality of partial areas with a first boundary of a processing target area in the point cloud data as a reference;
computing a feature value for each of the plurality of partial areas; and
correcting the processing target area by setting a new second boundary, based on a position of a partial area satisfying a reference relating to the feature value.

An example advantage according to the example aspect of the invention is maintaining precision in processing of generating information relating to an object by using point cloud data.

### BRIEF DESCRIPTION OF THE DRAWINGS

The above and other objects, advantages and features of the present invention will be more apparent from the following description of certain preferred example embodiments taken in conjunction with the accompanying drawings, in which:

FIG. 1 is a diagram illustrating a first example of a functional configuration of an image processing apparatus according to the present disclosure;

FIG. 2 is a diagram illustrating a hardware configuration of a computer for achieving the image processing apparatus according to the present disclosure;

FIG. 3 is a flowchart illustrating a first example of processing executed by the image processing apparatus according to the present disclosure;

FIG. 4 is a diagram illustrating a configuration of a system including the image processing apparatus according to the present disclosure;

FIG. 5 is a diagram illustrating one example of definition information;

FIG. 6 is a diagram illustrating a flow of setting a plurality of partial areas in point cloud data along a depth direction of a space to be measured;

FIG. 7 is a diagram illustrating a flow of setting a plurality of partial areas in point cloud data along a width direction of a space to be measured;

FIG. 8 is a diagram illustrating a first example of a flow of computing a feature value for each of a plurality of set partial areas;

FIG. 9 is a diagram illustrating a second example of a flow of computing a feature value for each of a plurality of set partial areas.

one example of processing performed by the second terminal;

FIG. 10 is a flowchart illustrating a flow of processing of correcting (setting) a boundary of a processing target area along a depth direction of a space to be measured;

FIG. 11 is a flowchart illustrating a flow of processing of correcting (setting) a boundary of a processing target area along a depth direction of a space to be measured;

FIG. 12 is a diagram illustrating an operation of setting a second boundary performed by an area correction unit;

FIG. 13 is a flowchart illustrating a flow of processing of correcting (setting) a boundary of a processing target area along a width direction of a space to be measured;

FIG. 14 is a flowchart illustrating a flow of processing of correcting (setting) a boundary of a processing target area along a width direction of a space to be measured;

FIG. 15 is a diagram illustrating one example of information for determining how to set a boundary of a processing target area in a width direction;

FIG. 16 is a diagram illustrating a specific example of an operation of moving a boundary of a processing target area in a width direction;

FIG. 17 is a diagram illustrating a second example of a functional configuration of the image processing apparatus according to the present disclosure;

FIG. 18 is a diagram illustrating a third example of a functional configuration of the image processing apparatus according to the present disclosure;

FIG. 19 is a flowchart illustrating a flow of processing executed by an object area determination unit according to the present disclosure; and

FIG. 20 is a diagram illustrating one example of information output by the object area determination unit.

### EXAMPLE EMBODIMENT

The invention will be now described herein with reference to illustrative example embodiments. Those skilled in the art will recognize that many alternative example embodiments can be accomplished using the teachings of the present invention and that the invention is not limited to the example embodiments illustrated for explanatory purposes.

Hereinafter, example embodiments according to the present disclosure will be described by using drawings. Note that, in the present disclosure, a drawing is associated with one or more example embodiments. Further, in every drawing, a similar component is given a similar sign, and description thereof is omitted as appropriate. Further, in each block diagram, each block represents not a configuration on a hardware basis but a configuration on a function basis, except as particularly described. Further, in a case where elements such as blocks in a figure are linked by an arrow, an orientation of the arrow is merely for ease of understanding a flow of information. In this case, the orientation of the arrow does not limit a direction of communication (unidirectional communication/bidirectional communication), unless otherwise stated.

Further, “acquisition” in the following description includes at least one of fetching (active acquisition), by an own apparatus, data or information stored in another apparatus or storage medium and inputting (passive acquisition), to an own apparatus, data or information output from another apparatus. Examples of active acquisition include requesting or inquiring another apparatus for data or information to receive a reply therefrom, accessing another apparatus or storage medium to read out data or information therefrom, and the like. Further, examples of passive acquisition include receiving delivered (transmitted, push-notified, or the like) information, and the like. Furthermore, “acquisition” may be selectively acquiring received data or information, or may be selectively receiving delivered data or information.

### Overview

An image processing apparatus described in the present disclosure includes a function for highly precisely recognizing a state of a space to be measured from a scan image (point cloud data) generated by scanning the space by using a scanning apparatus. Hereinafter, functions of the image processing apparatus according to the present disclosure will be described by using some example embodiments by way of illustration. Note that, the image processing apparatus according to the present disclosure is not limited to the following example embodiments.

### First Example Embodiment

### <Functional Configuration Example>

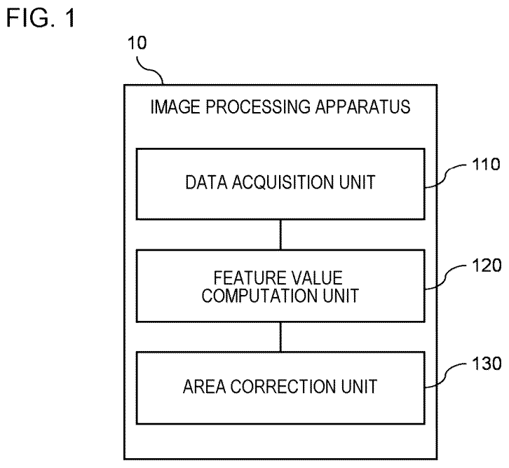

FIG. 1 is a diagram illustrating a first example of a functional configuration of an image processing apparatus according to the present disclosure. An image processing apparatus 10 illustrated in the present figure includes a data acquisition unit 110, a feature value computation unit 120, and an area correction unit 130.

The data acquisition unit 110 acquires point cloud data. The point cloud data are generated by scanning a space to be measured by using a scanning apparatus (not illustrated). For example, the data acquisition unit 110 is configured to read out target point cloud data at any timing from a database (not illustrated) that stores point cloud data generated by a scanning apparatus (not illustrated). Besides the above, the data acquisition unit 110 may be configured to communicate with a scanning apparatus (not illustrated) and acquire generated point cloud data.

The feature value computation unit 120 sets a plurality of partial areas with a first boundary of a processing target area in the point cloud data as a reference. The “processing target area” is set tentatively by using information defined in advance according to a range (a space to be measured) relevant to the point cloud data, which will be described later in detail. Further, the “processing target area” can be corrected as appropriate by the area correction unit 130 to be described later. Further, the feature value computation unit 120 computes a feature value for each of the set plurality of partial areas.

The area correction unit 130 corrects the processing target area as needed by using each feature value computed for each of the plurality of partial areas. The area correction unit 130 determines, based on the feature value for each of the plurality of partial areas, a partial area satisfying a reference relating to the feature value. The area correction unit 130 corrects the above-described processing target area by setting a new boundary (second boundary), based on a position of the determined partial area.

### <Hardware Configuration Example>

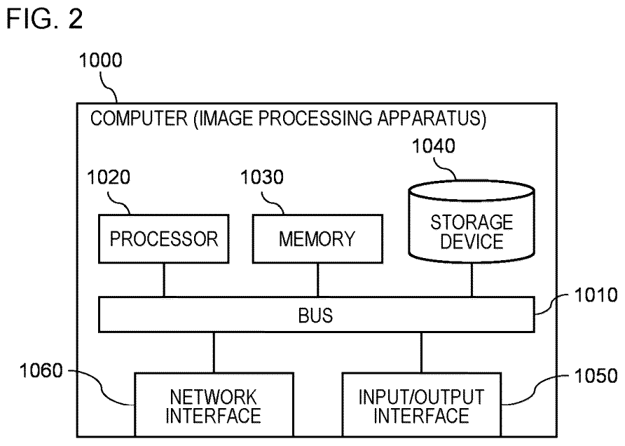

FIG. 2 is a diagram illustrating a hardware configuration of a computer for achieving the image processing apparatus according to the present disclosure.

A computer 1000 illustrated in the present figure includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from one another. However, a method of connecting the processor 1020 and the like with one another is not limited to bus connection.

The processor 1020 is a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores at least program modules for achieving functions (the data acquisition unit 110, the feature value computation unit 120, and the area correction unit 130) of the above-described image processing apparatus 10. Besides the above, the storage device 1040 may be used as a repository for a database that stores a result of measurement (point cloud data) by a scanning apparatus.

The processor 1020 achieves a function relevant to a program module read out from the storage device 1040 by expanding the program module into the memory 1030 and executing the program module. For example, the processor 1020 achieves the function of the data acquisition unit 110 described in the present disclosure by reading out a program module relevant to the data acquisition unit 110 into the memory 1030 and executing the program module. Similarly, the processor 1020 achieves the function of the feature value computation unit 120 described in the present disclosure by reading out a program module relevant to the feature value computation unit 120 into the memory 1030 and executing the program module. Similarly, the processor 1020 achieves the function of the area correction unit 130 described in the present disclosure by reading out a program module relevant to the area correction unit 130 into the memory 1030 and executing the program module. The operation of the processor 1020 is common to the example embodiments included in the present disclosure.

The program module described above may be recorded in a medium other than the storage device 1040. The medium for recording the program module includes any medium that can be used by the non-transitory tangible computer 1000. The medium for recording the program module may include an embedded program code that can be read by the computer 1000 (the processor 1020).

The input/output interface 1050 is an interface for connecting the computer 1000 (the image processing apparatus 10) to various kinds of equipment. The “various kinds of equipment” referred herein are, for example, but not particularly limited, input equipment such as an operation button, a keyboard, a touch panel, a mouse, and a microphone, and output equipment such as a display and a speaker.

The network interface 1060 is an interface for connecting the computer 1000 (the image processing apparatus 10) to a network. The network includes, for example, a local area network (LAN), a wide area network (WAN), and the like. The network interface 1060 supports various communication standards relating to wireless or wired, and establishes communication between the computer 1000 (the image processing apparatus 10) and another apparatus (not illustrated) on a network. The “another apparatus” includes, but not particularly limited, a server apparatus or the like including a database that stores a result of measurement (point cloud data) by a scanning apparatus. For example, the data acquisition unit 110 can communicate with the server apparatus via the network interface 1060 and acquire target point cloud data.

Further, the computer 1000 (the image processing apparatus 10) may be connected to the above-described “various kinds of equipment” via the network interface 1060.

### <Operation Example of Image Processing Apparatus>

Hereinafter, one example of an operation of the image processing apparatus according to the present disclosure will be described by using a figure.

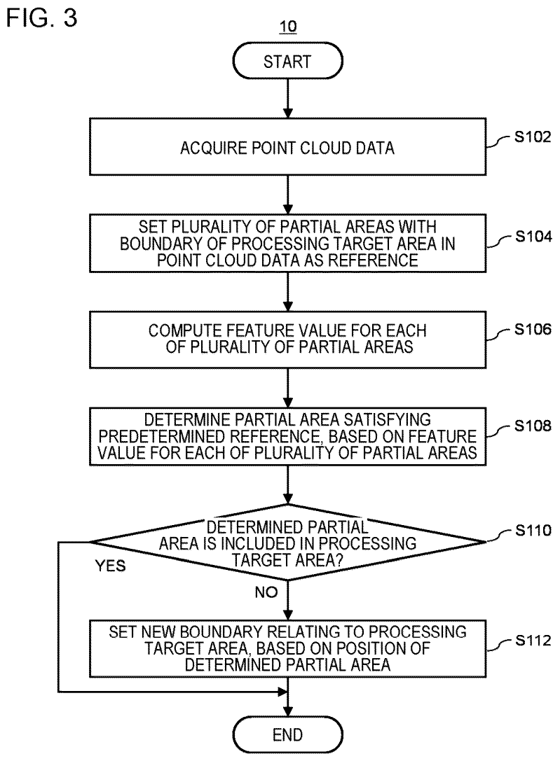

FIG. 3 is a flowchart illustrating a first example of processing executed by the image processing apparatus according to the present disclosure.

The data acquisition unit 110 acquires point cloud data (Step S102). For example, the data acquisition unit 110 accesses a database included in a not-illustrated server apparatus, and reads out target point cloud data from among pieces of point cloud data stored in the database.

Then, the feature value computation unit 120 sets a plurality of partial areas with a boundary (first boundary) of a processing target area in the point cloud data acquired in the processing in Step S102 as a reference (Step S104). Herein, the processing target area in the point cloud data is set tentatively by using information defined in advance according to a range (a space to be measured) relevant to the point cloud data. For example, the feature value computation unit 120 determines, based on information such as a position and a direction of a scanning apparatus at a timing at which a scan operation for generating point cloud data is executed, a space relevant to a range of the point cloud data. Then, the feature value computation unit 120 recognizes a processing target area in the point cloud data by using definition information of the processing target area (for example, information specifying position coordinates of the processing target area in a coordinate system of the point cloud data) associated in advance with the determined space. Herein, the definition information for determining the processing target area is saved in advance in a storage area accessible by the feature value computation unit 120 such as, for example, the storage device 1040 or a not-illustrated external apparatus. Then, the feature value computation unit 120 sets a plurality of partial areas in the point cloud data with a boundary (first boundary) of the processing target area in the point cloud data as a reference. For example, the feature value computation unit 120 sets, with a boundary of the processing target area as a reference, a plurality of rectangular areas having a predetermined size.

Then, the feature value computation unit 120 computes a feature value based on a point cloud for each of the set plurality of partial areas (Step S106). For example, the feature value computation unit 120 computes a feature value indicating a likeness of a surface of an object from the point cloud data. The “likeness of a surface of an object” can be estimated from an arrangement state of a point cloud such as, for example, a number or a density of points within the point cloud data. The feature value computation unit 120 computes at least one of a number and a density of points included in each of the plurality of partial areas as a feature value indicating “likeness of a surface of an object”.

The area correction unit 130 determines, based on the feature value computed for each of the plurality of partial areas, a partial area satisfying a predetermined reference relating to the feature value (Step S108). The “predetermined reference” referred herein is a reference for determining the above-described “likeness of a surface of an object”. For example, given a nature of point cloud data, a partial area relevant to a position of a surface of a certain object includes many points indicating the surface of the object, and a partial area relevant to a position other than the surface of the object includes relatively few such points. Thus, the area correction unit 130 can determine an area relevant to a position of a surface of an object, based on a change in feature values between partial areas. For example, the area correction unit 130 compares feature values between two neighboring partial areas in turn along a predetermined direction. Then, in a case where a large change relating to the feature value is observed for a partial area newly selected as a comparison target, the area correction unit 130 can predict that a surface of an object is highly likely to be positioned in the partial area or in an adjoining partial area. In this way, the area correction unit 130 can determine a partial area for which a large change in the feature value is observed as a “partial area satisfying a reference”.

Then, the area correction unit 130 executes processing of correcting the processing target area as follows, based on a position of the partial area determined as a “partial area satisfying a reference”. First, the area correction unit 130 determines whether the partial area determined as a “partial area satisfying a reference” is included in the processing target area (Step S110).

In a case where the partial area determined as a “partial area satisfying a reference” is included in the processing target area (Step S110: YES), the area correction unit 130 determines that the processing target area is set properly and ends the processing.

On the other hand, in a case where the partial area determined as a “partial area satisfying a reference” is not included in the processing target area (Step S110: NO), the area correction unit 130 sets a new boundary (second boundary) relating to the processing target area, based on a position of the determined partial area (Step S112). The processing of “setting a new boundary” may be, for example, processing of shifting the position of the processing target area set at that point in time without resizing, or may be processing of resizing (enlarging or reducing) the processing target area set at that point in time.

As described above, the image processing apparatus according to the present disclosure determines a partial area including a point cloud relevant to a surface of an object in acquired point cloud data, and determines whether a position of a default processing target area is proper, based on a position of the partial area. Further, in a case where the position of the default processing target area is not proper, the image processing apparatus according to the present disclosure corrects the processing target area by newly setting a boundary (second boundary) of the processing target area, based on the position of the determined partial area.

With such an operation, it becomes possible to execute subsequent information processing on a target area including important features (a point cloud) in relation to an object regarding which determination is to be made. That is, the image processing apparatus according to the present disclosure, a problem of maintaining precision in processing of generating information relating to an object by using point cloud data is solved. Further, according to the present disclosure, an image processing method executed by the image processing apparatus (computer) and a program for achieving functions of the image processing apparatus (computer) are provided. Further, according to the present disclosure, a computer-readable medium for recording the program is also provided.

Hereinafter, a detailed example of the image processing apparatus according to the present disclosure will be described.

### <System Configuration>

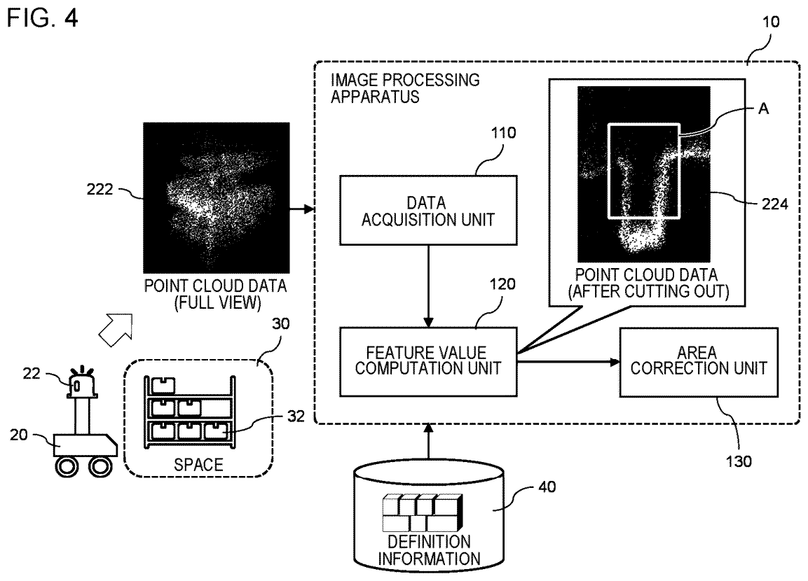

FIG. 4 is a diagram illustrating a configuration of a system including the image processing apparatus according to the present disclosure. The system illustrated in the present figure is configured by including a scanning apparatus 22 in addition to the above-described image processing apparatus 10. In the example in the present figure, the scanning apparatus 22 is provided on an autonomously movable robot 20.

The scanning apparatus 22 is an apparatus that generates point cloud data three-dimensionally indicating a position or a shape of an object present in a surrounding area by scanning the surrounding area by using a pulsed laser such as, for example, light detection and ranging (LiDAR).

The robot 20 moves autonomously according to a route set in advance while estimating a self-location, based on an output of not-illustrated various kinds of sensors. Further, the robot 20 scans a space 30 including a target object 32 by controlling the scanning apparatus 22 while moving autonomously. As a result, point cloud data 222 relating to a space to be measured are generated. The generated point cloud data 222 may be transmitted at any timing to the image processing apparatus 10, or may be stored temporarily in a not-illustrated server apparatus.

The data acquisition unit 110 of the image processing apparatus 10 acquires the point cloud data 222 generated by the scanning apparatus 22. For example, the data acquisition unit 110 of the image processing apparatus 10 can acquire the point cloud data 222 generated by a scan operation of the scanning apparatus 22 by communicating with the scanning apparatus 22 via a not-illustrated network. Besides the above, in a case where a scan result (the point cloud data 222) generated by the scanning apparatus 22 is saved temporarily in a not-illustrated database, the data acquisition unit 110 of the image processing apparatus 10 may acquire the point cloud data 222 by accessing the not-illustrated database.

Then, the feature value computation unit 120 of the image processing apparatus 10 recognizes a processing target area in the acquired point cloud data 222 by using definition information associated with a space relevant to the point cloud data 222.

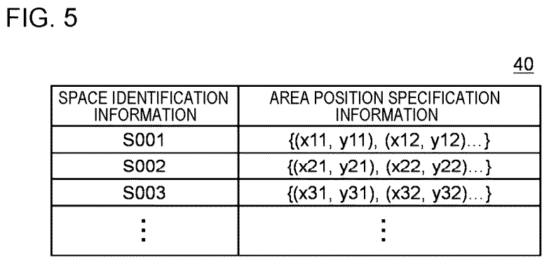

In the example in FIG. 4, the definition information is saved in advance in a predetermined database 40. The definition information stored in the database 40 is prepared in advance based on, for example, map information of each space generated by simultaneous localization and mapping (SLAM) or the like. The definition information includes, in association with information indicating a space relevant to point cloud data, information specifying an area where a target object is positioned in the space, that is, a position (position coordinates in a coordinate system of point cloud data) of a processing target area. FIG. 5 is a diagram illustrating one example of definition information. In the example in the present figure, the definition information includes, in association with information (space identification information) identifying each space, information (area position specification information) indicating a position of a processing target area in point cloud data generated by scanning the space. The feature value computation unit 120 of the image processing apparatus 10 can determine and read out relevant definition information, based on information identifying a space relevant to the point cloud data 222. The “information identifying a space” may be linked in advance to the point cloud data 222, or may be input manually by a user of the image processing apparatus 10.

In the example in FIG. 4, the feature value computation unit 120 of the image processing apparatus 10 cuts out, from the point cloud data 222 relevant to a full view of a space to be measured, point cloud data 224 relevant to a part of the full view. For example, the feature value computation unit 120 of the image processing apparatus 10 identifies a predetermined range including a recognized processing target area and a surrounding area thereof, and cuts out point cloud data included in the predetermined range from the point cloud data 222. Thereby, the point cloud data 224 as illustrated in FIG. 4 are generated. Note that, in the example in FIG. 4, the feature value computation unit 120 of the image processing apparatus 10 recognizes an area A surrounded by a white solid line in the point cloud data 224 as a processing target area.

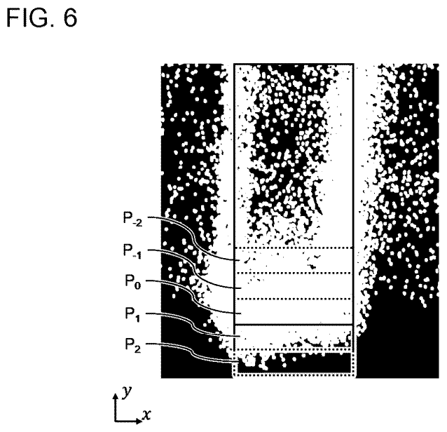

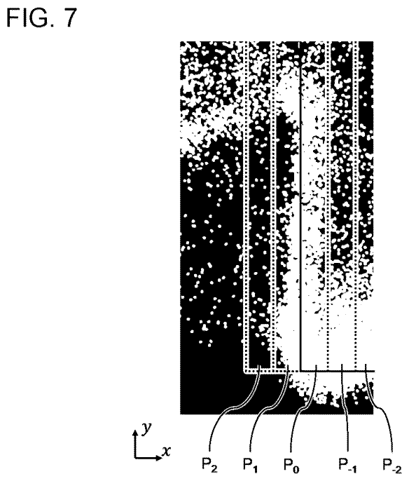

Then, the feature value computation unit 120 of the image processing apparatus 10 sets a plurality of partial areas, based on the recognized processing target area. One example of a flow of setting a plurality of partial areas will be described by using FIGS. 6 and 7.

FIG. 6 is a diagram illustrating a flow of setting a plurality of partial areas in the point cloud data 222 along a depth direction of a space to be measured. An x-axis in the figure indicates a width direction of the space to be measured, and a y-axis in the figure indicates the depth direction of the space to be measured. Further, a solid line in FIG. 6 indicates a boundary (first boundary) of a processing target area set at that point in time. The feature value computation unit 120 of the image processing apparatus 10 slices, along the width direction (the x-axis in the figure), a point cloud with a predetermined thickness as illustrated by dotted lines in the figure, with the boundary (first boundary) of the processing target area as a reference. Thereby, a plurality of areas having a predetermined thickness in the depth direction (the y-axis in the figure) are set. Note that, in the example in FIG. 6, five partial areas (P⁻², P⁻¹, P₀, P₁, P₂) having a predetermined thickness in the depth direction (the y-axis in the figure) are set. Herein, the number of partial areas is set, for example, in such a way as to become about twice as large or more as an assumed error in self-location estimation of the robot 20, with the assumed error as a reference.

FIG. 7 is a diagram illustrating a flow of setting a plurality of partial areas in the point cloud data 222 along a width direction of a space to be measured. An x-axis in the figure indicates the width direction of the space to be measured, and a y-axis in the figure indicates a depth direction of the space to be measured. Further, a solid line in FIG. 7 indicates a boundary (first boundary) of a processing target area set at that point in time. The feature value computation unit 120 of the image processing apparatus 10 slices, along the depth direction (the y-axis in the figure), a point cloud with a predetermined thickness as illustrated by dotted lines in the figure, with the boundary (first boundary) of the processing target area as a reference. Thereby, a plurality of areas having a predetermined thickness in the width direction (the x-axis in the figure) are set. Note that, in the example in FIG. 7, five partial areas (P₋₂, P⁻¹, P₀, P₁, P₂) having a predetermined thickness in the width direction (the x-axis in the figure) are set. Herein, the number of partial areas is set, for example, in such a way as to become about twice as large or more as an assumed error in self-location estimation of the robot 20, with the assumed error as a reference.

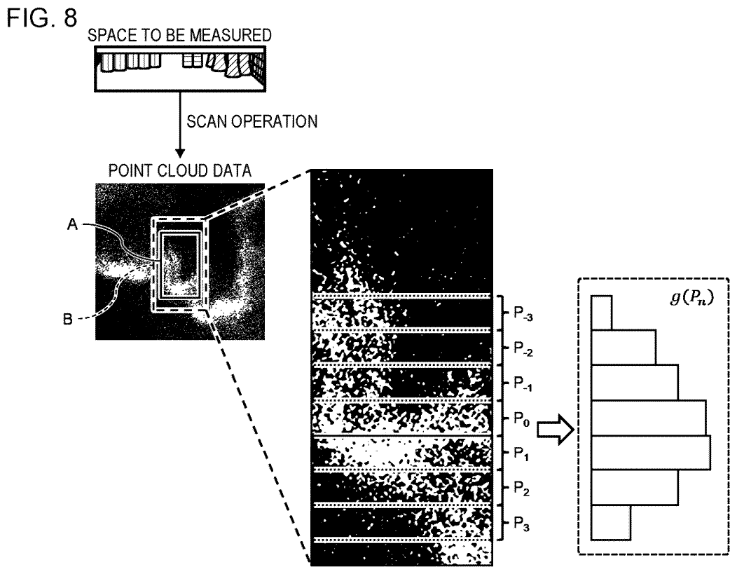

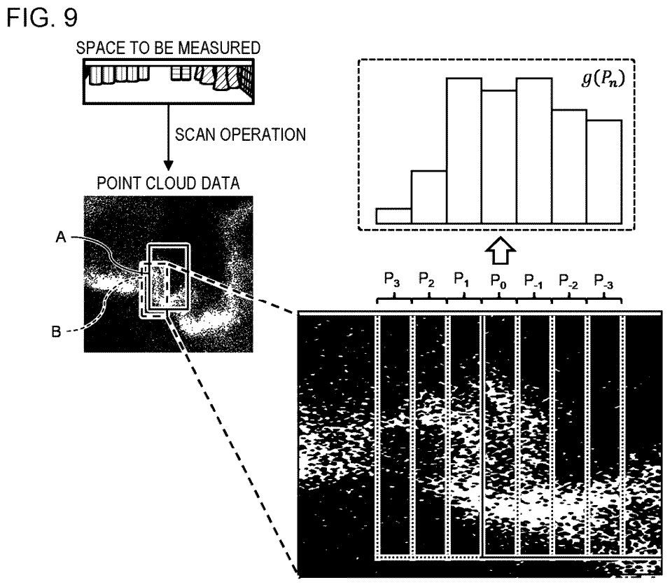

Then, the feature value computation unit 120 of the image processing apparatus 10 computes a feature value for each of the plurality of partial areas as described above. Specifically, the feature value computation unit 120 of the image processing apparatus 10 computes the number or a density of points included in each partial area as a feature value. A flow of computing a feature value for each of a plurality of partial areas will be described by using FIGS. 8 and 9.

FIG. 8 is a diagram illustrating a first example of a flow of computing a feature value for each of a plurality of set partial areas. In the example in FIG. 8, an area A surrounded by a solid line is set as a processing target area in point cloud data relevant to a space to be measured. In the example in the present figure, a plurality of partial areas are set along a depth direction of the space to be measured, as described by using FIG. 6. Specifically, a plurality of partial areas (P₋₃, P₋₂, P⁻¹, P₀, P₁, P₂, P₃) are set, as illustrated in an enlarged part (middle of the figure) of an area surrounded by a dashed line B. Herein, the feature value computation unit 120 of the image processing apparatus 10 uses a predetermined function g(Pₙ) that outputs a likeness of a surface of an object as a numerical value (feature value), with the number of points included in each partial area as a parameter. A histogram in FIG. 8 indicates a result of giving a point cloud included in each of the plurality of partial areas as a parameter to the predetermined function g(Pₙ).

FIG. 9 is a diagram illustrating a second example of a flow of computing a feature value for each of a plurality of set partial areas. In the example in FIG. 9, an area A surrounded by a solid line is set as a processing target area in point cloud data relevant to a space to be measured. In the example in the present figure, a plurality of partial areas are set along a width direction of the space to be measured, as described by using FIG. 7. Specifically, a plurality of partial areas (P⁻³, P₋₂, P₋₁, P₀, P₁, P₂, P₃) are set, as illustrated in an enlarged part (middle of the figure) of an area surrounded by a dashed line B. Herein, the feature value computation unit 120 of the image processing apparatus 10 uses a predetermined function g(Pₙ) that outputs likeness of a surface of an object as a numerical value (feature value), with the number of points included in each partial area as a parameter. A histogram in FIG. 9 indicates a result of giving a point cloud included in each of the plurality of partial areas as a parameter to the predetermined function g(Pₙ).

Then, the area correction unit 130 of the image processing apparatus 10 corrects the processing target area as appropriate, based on the feature value computed for each of the plurality of partial areas. A flow of correcting a processing target area based on a feature value computed for each of a plurality of partial areas will be described by using flowcharts below.

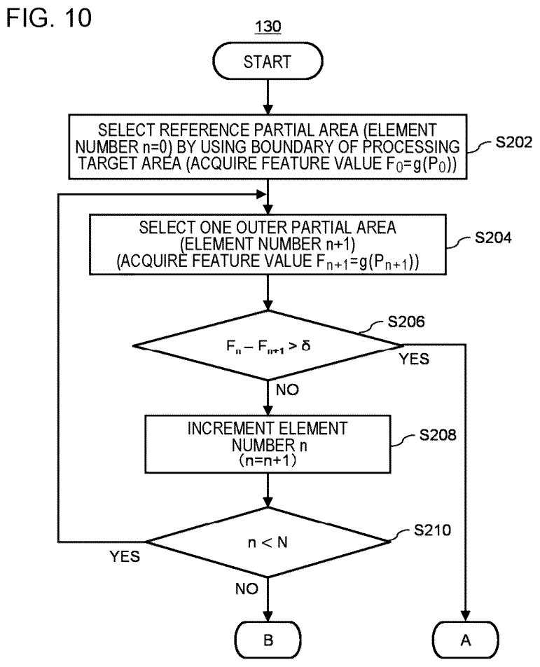

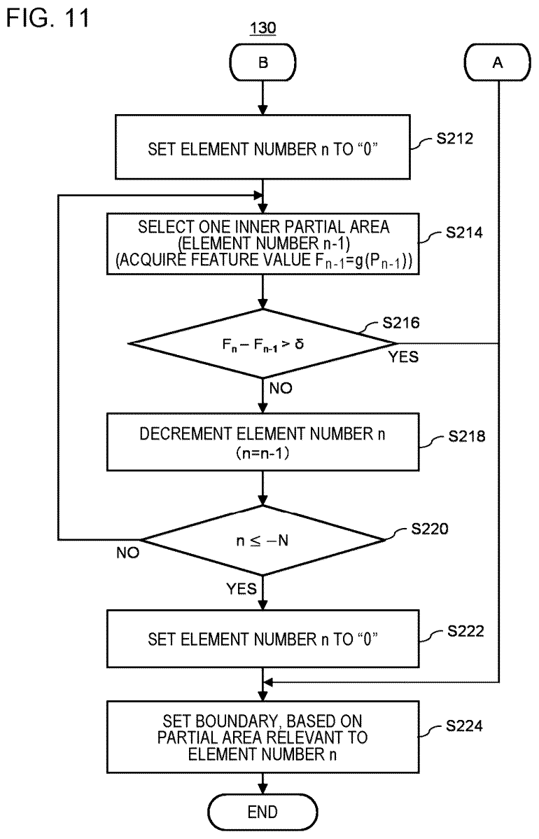

FIGS. 10 and 11 are flowcharts illustrating a flow of processing of correcting (setting) a boundary of a processing target area along a depth direction of a space to be measured.

First, the area correction unit 130 selects a reference partial area (element number n=0) by using a boundary of a processing target area (Step S202). For example, it is assumed that a plurality of partial areas are set as illustrated in FIG. 8. In this case, the area correction unit 130 selects, as a reference partial area (first partial area), a partial area P₀ with a boundary (first boundary) of a processing target area set at that point in time as a reference. Then, with the partial area (first partial area) selected in the processing in Step S202 as a starting point, search processing of searching for two mutually neighboring partial areas where a difference between feature values is equal to or more than a reference value is executed.

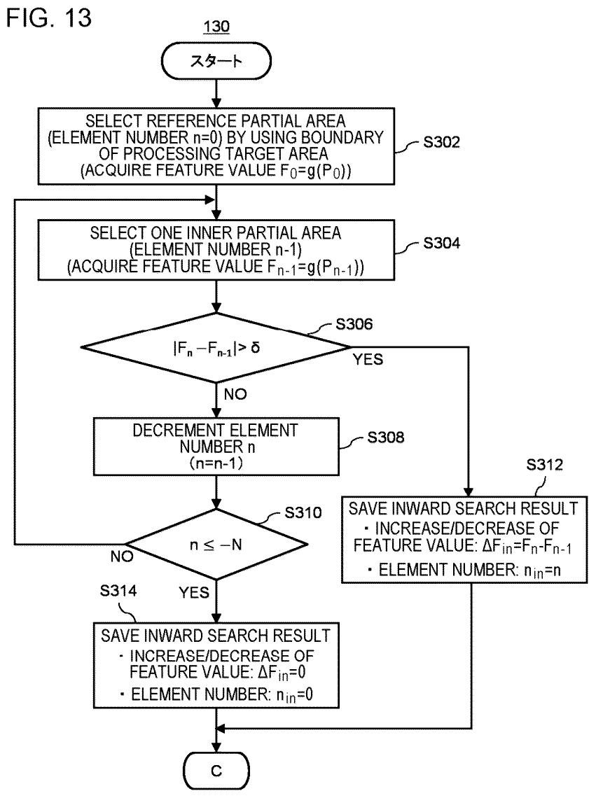

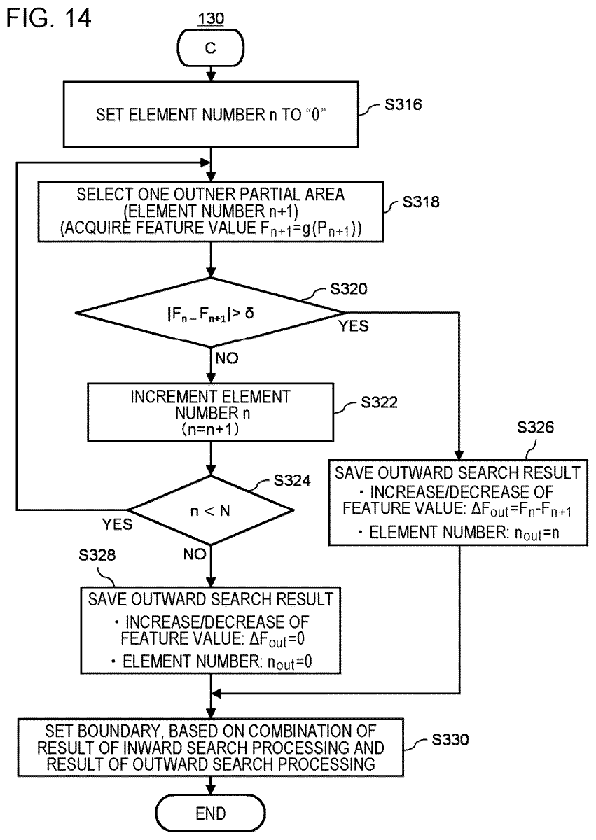

Herein, two directions are determined with the reference partial area (first partial area) as a starting point. That is, the two directions are a first direction, going outward of the processing target area along the depth direction, and a second direction (opposite from the first direction), going inward of the processing target area along the depth direction. The area correction unit 130 executes search processing in the first direction or the second direction. Note that, in flowcharts illustrated in FIGS. 13 and 14, search processing in the first direction is executed preferentially. The reason is to prevent an important feature (a feature indicating a likeness of a target object surface) of point cloud data generated by the scanning apparatus 22 from being located outside the processing target area. For example, discrepancy may occur between a position in definition information and a position in point cloud data due to a factor such as an error in a self-location estimated by the robot 20. In such a case, the above-described important feature may not be included in a processing target area recognized on the point cloud data based on the definition information. Thus, it can be said that the first direction outward from the processing target area is preferably prioritized in a depth direction of a space to be measured.

Returning to FIGS. 10 and 11, the area correction unit 130 selects one outer partial area (element number n+1) positioned adjoining the partial area selected in the processing in Step S202 (Step S204). For example, in a case where the partial area P₀ illustrated in FIG. 8 is selected, the area correction unit 130 selects an element number n+1, that is, a partial area P₁ with an element number of “1”.

That is, the area correction unit 130 selects two partial areas mutually adjoining in the depth direction in the processing in Steps S202 and S204. Further, the area correction unit 130 acquires a feature value computed for each of the two selected partial areas in the processing in Steps S202 and S204. In an initial stage, the area correction unit 130 acquires a feature value g(P₀) computed for the partial area P₀ selected as the “reference partial area” by using the above-described predetermined function g(Pₙ). Similarly, the area correction unit 130 acquires a feature value g(P₁) computed for the partial area P₁ by using the above-described predetermined function g(Pₙ). Note that, in the following description, a feature value computed for a partial area relevant to an element number n will be also written as “Fₙ”.

Next, the area correction unit 130 computes a difference (Fₙ−Fₙ₊₁) between feature values of the two selected partial areas, and determines whether the computed difference (Fₙ−Fₙ₊₁) between feature values exceeds a predetermined reference value δ (Step S206). In other words, the area correction unit 130 determines whether a feature value in one outer partial area is smaller by the reference value or more. Two neighboring partial areas where a change in feature values is equal to or more than the reference value means that the two partial areas include an important feature (a feature indicating a likeness of a target object surface). Specifically, in a case where a feature value decreased by the reference value or more is seen in “one outer partial area”, it can be said that the other partial area includes a “feature implicating presence of a surface of a target object” appearing as a point cloud. In the present Step S206, it can be also said that the area correction unit 130 determines a partial area including such a feature.

In a case where the computed difference (Fₙ−Fₙ₊₁) between feature values exceeds the predetermined reference value δ (Step S206: YES), the area correction unit 130 ends the search processing and executes processing in Step S224 to be described later. On the other hand, in a case where the computed difference (Fₙ−Fₙ₊₁) between feature values does not exceed the predetermined reference value δ (Step S206: NO), the area correction unit 130 increments the element number n relating to the partial area (Step S208). With this operation, the partial area to be a target of search processing shifts outward by one.

Further, the area correction unit 130 determines whether the incremented element number n reaches an upper limit N based on the partial area set by the feature value computation unit 120 (Step S210). In other words, in the present Step S210, the area correction unit 130 determines whether an outermost partial area (that is, a partial area where the element number n is “N”) in the first direction is selected as a comparison target.

In a case where the element number n does not reach the upper limit N (Step S210: YES), the processing in Steps S204 and S206 is repeated for the above-described “one outer partial area” and “another one outer partial area”. On the other hand, in a case where the element number n reaches the upper limit N (Step S210: NO), the area correction unit 130 executes search processing for the second direction (direction inward of the processing target area).

Upon starting search processing for the second direction (direction inward of the processing target area), the area correction unit 130 sets the element number n to “0” (Step S212). This initializes the target partial area. That is, the partial area P₀ is selected again.

Then, the area correction unit 130 selects one inner partial area (element number n−1) positioned adjoining the selected partial area (partial area P₀) (Step S214). Further, at this time, the area correction unit 130 acquires a feature value relevant to the selected partial area. For example, in a case where the partial area P₀ illustrated in FIG. 8 is selected, the area correction unit 130 selects an element number n−1, that is, a partial area P₋₁ with an element number of “−1”. Further, the area correction unit 130 acquires a feature value g(P₋₁) computed for the partial area P₋₁ by using the above-described predetermined function g(Pₙ). The processing in Step S214 is similar to the processing in Step S204.

Next, the area correction unit 130 computes a difference (Fₙ−Fₙ₋₁) between feature values of the two selected partial areas, and determines whether the computed difference (Fₙ−Fₙ₋₁) between feature values exceeds a predetermined reference value δ (Step S216). In other words, the area correction unit 130 determines whether a feature value in one inner partial area is smaller by the reference value or more. Similarly to the processing for the outward direction, two neighboring partial areas where a change in feature values is equal to or more than the reference value means that the two partial areas include an important feature (a feature indicating a likeness of a target object surface). Specifically, in a case where a feature value decreased by the reference value or more is seen in “one inner partial area”, it can be said that the other partial area includes a “feature implicating presence of a surface of a target object” appearing as a point cloud. In the present Step S216, it can be also said that the area correction unit 130 determines a partial area including such a feature.

In a case where the computed difference (Fₙ−Fₙ₋₁) between feature values exceeds the predetermined reference value δ (Step S216: YES), the area correction unit 130 ends the search processing and executes processing in Step S224 to be described later. On the other hand, in a case where the computed difference (Fₙ−Fₙ₋₁) between feature values does not exceed the predetermined reference value δ (Step S216: NO), the area correction unit 130 decrements the element number n relating to the partial area (Step S218). With this operation, the partial area to be a target of search processing shifts inward by one.

Further, the area correction unit 130 determines whether the decremented element number n reaches an upper limit-N based on the partial area set by the feature value computation unit 120 (Step S220). In other words, in the present Step S220, the area correction unit 130 determines whether an outermost partial area (that is, a partial area where the element number n is “−N”) in the second direction is selected as a comparison target.

In a case where the element number n does not reach the upper limit-N(Step S220: NO), the processing in Steps S214 and S216 is repeated for the above-described “one inner partial area” and “another one inner partial area”. On the other hand, in a case where the element number n reaches the upper limit-N(Step S220: YES), the area correction unit 130 sets the element number n to “0”, that is, an initial value (S222). With this, the search processing ends.

After the search processing ends, the area correction unit 130 sets a boundary, based on a partial area relevant to the element number n set at a point in time of the end of search processing (Step S224). As one example, in a case where the element number n set at a point in time of the end of search processing is “2”, the area correction unit 130 sets a new boundary (second boundary) of the processing target area, based on a partial area P₂ relevant to the element number. Herein, the case where the element number n is “2” means that a feature value of the partial area P₂ is greater than a feature value of a partial area P₃ by the reference value or more. That is, in a case where two partial areas where the difference between feature values is equal to or more than the reference value are found, the area correction unit 130 sets a new boundary (second boundary) of the processing target area, based on a partial area (second partial area) for which the feature value is greater between the two partial areas.

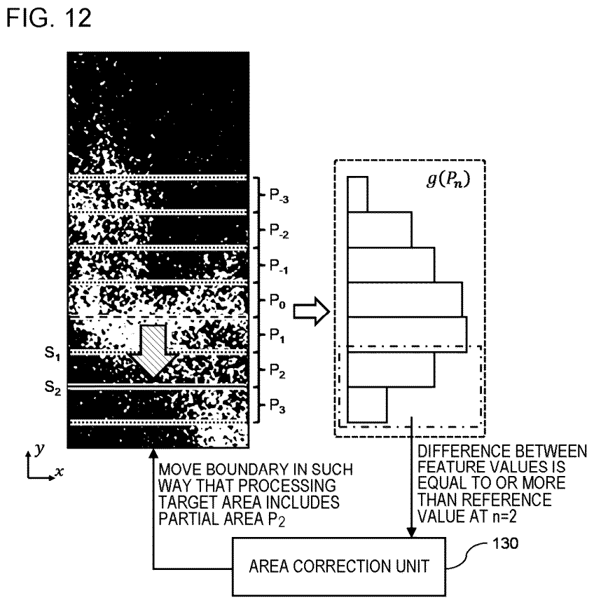

The area correction unit 130 moves the boundary (first boundary) of the processing target area along any one of a plurality of sides of the partial area P₂ (second partial area) extending in a direction (width direction) crossing the depth direction of the space to be measured, as illustrated in, for example, FIG. 12. FIG. 12 is a diagram illustrating an operation of setting a second boundary performed by the area correction unit. In the example in FIG. 12, the area correction unit 130 selects, between sides S1 and S2 of the partial area P₂ extending in the width direction (x-axis direction in the figure), a side S2 such that the partial area P₂ is included in the processing target area, and moves the boundary (first boundary) of the processing target area to a position of the side S2. With such an operation, a new boundary (second boundary) of the processing target area is set.

FIGS. 13 and 14 are flowcharts illustrating a flow of processing of correcting (setting) a boundary of a processing target area along a width direction of a space to be measured.

First, the area correction unit 130 selects a reference partial area (element number n=0) by using a boundary of a processing target area (Step S302). For example, it is assumed that a plurality of partial areas are set as illustrated in FIG. 9. In this case, the area correction unit 130 selects, as a reference partial area (first partial area), a partial area P₀ with a boundary (first boundary) of a processing target area set at that point in time as a reference. Then, with the partial area (first partial area) selected in the processing in Step S302 as a starting point, search processing of searching for two mutually neighboring partial areas where a difference between feature values is equal to or more than a reference value is executed.

Herein, two directions are determined with the reference partial area (first partial area) as a starting point. That is, the two directions are a third direction, going inward of the processing target area along the width direction, and a fourth direction (opposite from the third direction), going outward of the processing target area along the width direction. The area correction unit 130 executes search processing in the third direction and the fourth direction, as described later. In the flowcharts illustrated in FIGS. 13 and 14, search processing in the third direction is executed, and thereafter search processing in the fourth direction is executed. However, execution order of search processing in the width direction is not limited thereto. The area correction unit 130 may execute search processing in the fourth direction first, or may execute search processing in the third direction and search processing in the fourth direction in parallel.

Returning to FIGS. 13 and 14, the area correction unit 130 selects one inner partial area (element number n−1) positioned adjoining the partial area selected in the processing in Step S302 (Step S304). For example, in a case where the partial area P₀ illustrated in FIG. 9 is selected, the area correction unit 130 selects an element number n−1, that is, a partial area P₋₁ with an element number of “−1”.

That is, the area correction unit 130 selects two partial areas mutually adjoining in the width direction in the processing in Steps S302 and S304. Further, the area correction unit 130 acquires a feature value computed for each of the two selected partial areas in the processing in Steps S302 and S304. In an initial stage, the area correction unit 130 acquires a feature value g(P₀) computed for the partial area P₀ selected as the “reference partial area” by using the above-described predetermined function g(Pₙ). Similarly, the area correction unit 130 acquires a feature value g(P₁) computed for the partial area P₁ by using the above-described predetermined function g(Pₙ). Note that, in the following description, a feature value computed for a partial area relevant to an element number n will be also written as “En”.

Next, the area correction unit 130 computes an absolute value (|Fₙ−Fₙ₋₁|) of a difference between feature values of the two selected partial areas, and determines whether the computed absolute value (|Fₙ−Fₙ₋₁|) of the difference between feature values exceeds a predetermined reference value δ (Step S306). Herein, the reason of using the “absolute value of the difference between feature values” in search processing in the width direction is that different types of target objects may be arranged in the width direction. For example, at a location in the width direction where the types of target objects switch, a certain degree of increasing or decreasing trend regarding a feature value of point cloud data (the number or a density of points in point cloud data) appears. In the present Step S306, it can be also said that the area correction unit 130 determines a partial area including such a feature.

In a case where the computed absolute value (|Fₙ−Fₙ₋₁) of the difference between feature values exceeds the predetermined reference value δ (Step S306: YES), the area correction unit 130 ends the inward (third direction) search processing and saves a result thereof (Step S312). As one example, the area correction unit 130 sets “Fₙ−Fₙ₋₁” as an inward (third direction) increasing/decreasing trend ΔFᵢₙ of a feature value. Alternatively, the area correction unit 130 may save a sign (+, −) based on computation of “Fₙ−Fₙ₋₁” as an inward (third direction) increasing/decreasing trend ΔFᵢₙ of a feature value. Further, the area correction unit 130 saves the element number n at that point in time as an element number nᵢₙ relating to the inward (third direction) search processing. Thereafter, the area correction unit 130 executes outward (fourth direction) search processing, as described later.

On the other hand, in a case where the computed absolute value (|Fₙ−Fₙ₋₁|) of the difference between feature values does not exceed the predetermined reference value δ (Step S306: NO), the area correction unit 130 decrements the element number n relating to the partial area (Step S308). With this operation, the partial area to be a target of search processing shifts inward by one.

Further, the area correction unit 130 determines whether the decremented element number n reaches an upper limit-N based on the partial area set by the feature value computation unit 120 (Step S310). In other words, in the present Step S310, the area correction unit 130 determines whether an outermost partial area (that is, a partial area where the element number n is “−N”) in the third direction is selected as a comparison target.

In a case where the element number n does not reach the upper limit-N(Step S310: NO), the processing in Steps S304 and S306 is repeated for the above-described “one inner partial area” and “another one inner partial area”. On the other hand, in a case where the element number n reaches the upper limit-N(Step S310: YES), the area correction unit 130 ends the inward (third direction) search processing and saves a result thereof (Step S314). This is a case where no adjoining two partial areas where the absolute value of the difference between feature values exceeds the reference value are found. In this case, the area correction unit 130 sets, for example, “0” or the like indicating absence of a sign as an inward (third direction) increasing/decreasing trend ΔFᵢₙ of a feature value. Further, the area correction unit 130 sets an initial value (0) as the element number nᵢₙ relating to the inward (third direction) search processing. Thereafter, the area correction unit 130 executes outward (fourth direction) search processing, as described later.

Upon starting search processing for outside (fourth direction), the area correction unit 130 sets the element number n to “0” (Step S316). Thereby, the target partial area is initialized. That is, the partial area P₀ is selected again.

Then, the area correction unit 130 selects one outer partial area (element number n+1) positioned adjoining the selected partial area (partial area P₀) (Step S318). Further, at this time, the area correction unit 130 acquires a feature value relevant to the selected partial area. For example, in a case where the partial area P₀ illustrated in FIG. 9 is selected, the area correction unit 130 selects an element number n+1, that is, a partial area P₁ with an element number of “1”. Further, the area correction unit 130 acquires a feature value g(P₁) computed for the partial area P₁ by using the above-described predetermined function g(Pₙ). The processing in Step S318 is similar to the processing in Step S304.

Next, the area correction unit 130 computes an absolute value (|Fₙ-Fₙ+1) of a difference between feature values of the two selected partial areas, and determines whether the computed absolute value (|Fₙ−Fₙ₊₁|) of the difference between feature values exceeds a predetermined reference value δ (Step S320).

In a case where the computed absolute value (|Fₙ−Fₙ₊₁|) of the difference between feature values exceeds the predetermined reference value δ (Step S320: YES), the area correction unit 130 ends the outward (fourth direction) search processing and saves a result thereof (Step S326). As one example, the area correction unit 130 sets “Fₙ−Fₙ₊₁” as an outward (fourth direction) increasing/decreasing trend ΔFₒᵤₜ of a feature value. Alternatively, the area correction unit 130 may save information on a sign (+, −) based on computation of “Fₙ−Fₙ₊₁” as an outward (fourth direction) increasing/decreasing trend ΔFₒᵤₜ of a feature value. Further, the area correction unit 130 saves the element number n at that point in time as an element number nₒᵤₜ relating to the outward (fourth direction) search processing. Thereafter, processing of setting a boundary of the processing target area is executed based on a combination of the result of the inward (third direction) search processing and the result of the outward (fourth direction) search processing. On the other hand, in a case where the computed absolute value (|Fₙ−Fₙ₊₁|) of the difference between feature values does not exceed the predetermined reference value δ (Step S320: NO), the area correction unit 130 increments the element number n relating to the partial area (Step S322). With this operation, the partial area to be a target of search processing shifts outward by one.

Further, the area correction unit 130 determines whether the incremented element number n reaches an upper limit N based on the partial area set by the feature value computation unit 120 (Step S324). In other words, in the present Step S324, the area correction unit 130 determines whether an outermost partial area (that is, a partial area where the element number n is “N”) inside (third direction) is selected as a comparison target.

In a case where the element number n does not reach the upper limit N (Step S324: YES), the processing in Steps S318 and S320 is repeated for the above-described “one outer partial area” and “another one outer partial area”. On the other hand, in a case where the element number n reaches the upper limit N (Step S324: NO), the area correction unit 130 ends the outward (fourth direction) search processing and saves a result thereof (Step S328). This is a case where no adjoining two partial areas where the absolute value of the difference between feature values exceeds the reference value are found. In this case, the area correction unit 130 sets, for example, “0” or the like indicating absence of a sign as an outward (fourth direction) increasing/decreasing trend ΔFₒᵤₜ of a feature value. Further, the area correction unit 130 sets an initial value (0) as the element number nₒᵤₜ relating to the outward (fourth direction) search processing. Thereafter, processing of setting a boundary of the processing target area is executed based on a combination of the result of the inward (third direction) search processing and the result of the outward (fourth direction) search processing.

After the search processing in the third and fourth directions ends, the area correction unit 130 sets a boundary of the processing target area, based on a combination of the result of the inward (third direction) search processing and the result of the outward (fourth direction) search processing (Step S330).

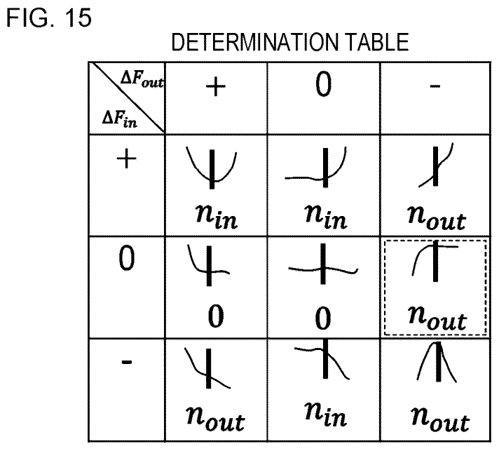

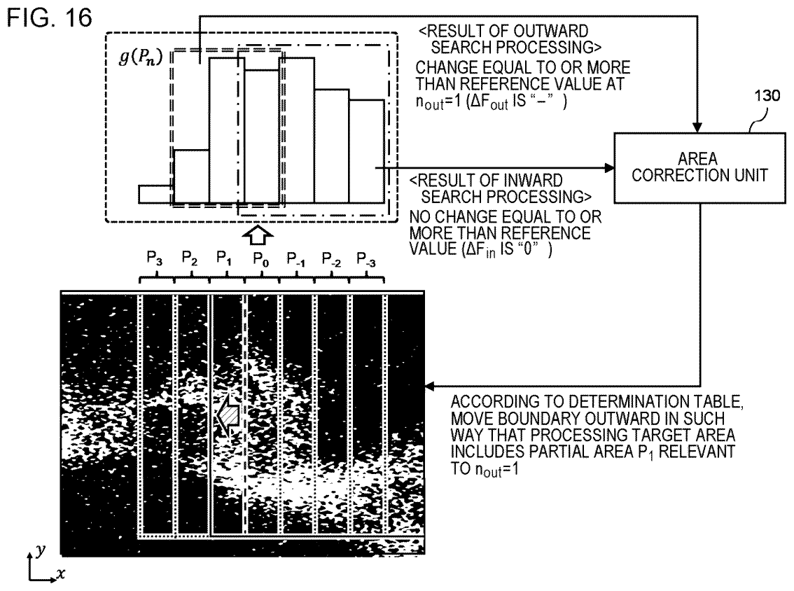

As one example, the area correction unit 130 determines, by using a table illustrated in FIG. 15, whether to set a new boundary (second boundary) for the processing target area and how to move the current boundary (first boundary) in the width direction in a case of setting a new boundary (second boundary). FIG. 15 is a diagram illustrating one example of information for determining how to set a boundary of the processing target area in the width direction. A specific example of an operation of moving the boundary of the processing target area in the width direction by using the determination table illustrated in FIG. 15 will be described by using another figure (FIG. 16).

FIG. 16 is a diagram illustrating a specific example of an operation of moving the boundary of the processing target area in the width direction. In the specific example in FIG. 16, the result of the inward (third direction) search processing and the result of the outward (fourth direction) search processing are acquired as follows, respectively.
The result of the inward (third direction) search processing: No change equal to or more than the reference value (ΔFᵢₙ is “0”)
The result of the outward (fourth direction) search processing: Change equal to or more than the reference value at nₒᵤₜ=1 (ΔFₒᵤₜ is “−”)

In this case, the area correction unit 130 determines a content relevant to a combination of the increasing/decreasing trend (ΔFᵢₙ is “0”) of a feature value determined in the inward (third direction) search processing and the increasing/decreasing trend (ΔFₒᵤₜ is “−”) of a feature value determined in the outward (fourth direction) search result. Specifically, the area correction unit 130 determines a content surrounded by a dashed line in FIG. 15 as a content relevant to the combination. Then, the area correction unit 130 determines that “it is necessary to set a new boundary (second boundary) for the processing target area”, based on the determined content. Further, the area correction unit 130 determines that “it is necessary to move the boundary of the processing target area outward (fourth direction) in such a way as to include the partial area (that is, the partial area P₁) relevant to the element number nₒᵤₜ”, based on the same content. As a result, a new boundary (second boundary) of the processing target area is set, as illustrated.

As described above, the image processing apparatus according to the present disclosure determines, from a point cloud included in a plurality of partial areas set in the vicinity of a processing target area, a partial area where a feature indicating a likeness of a surface of a measurement target appears, and corrects a boundary of the processing target area as appropriate based on the partial area. Such a configuration allows the processing target area to include a feature important in object determination processing using point cloud data. As a result, an effect of improving precision in object determination processing executed in a subsequent process can be expected.

### Modified Example

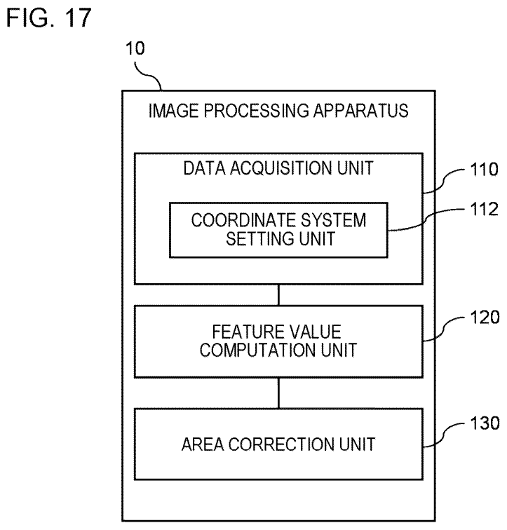

FIG. 17 is a diagram illustrating a second example of a functional configuration of the image processing apparatus according to the present disclosure. In the image processing apparatus 10 illustrated in the present figure, the data acquisition unit 110 further includes a coordinate system setting unit 112.

For example, the coordinate system setting unit 112 matches a coordinate system of acquired point cloud data to a coordinate system set in definition information. As one example, the coordinate system setting unit 112 transforms a coordinate system of acquired point cloud data according to a coordinate system in definition information associated with a space relevant to the acquired point cloud data.

For example, the coordinate system setting unit 112 acquires, as additional information relating to point cloud data, information relating to a self-location of the robot 20 at timing when the point cloud data are acquired. The information relating to a self-location includes, for example, information indicating a self-location (estimated location) of the robot 20 at a time of acquiring the point cloud data and a pose (orientation of the robot 20 or the scanning apparatus 22) upon acquiring the point cloud data. The coordinate system setting unit 112 computes a coordinate system of the acquired point cloud data, based on the information relating to a self-location. Then, the coordinate system setting unit 112 computes a matrix for transforming the coordinate system of the point cloud data into a coordinate system of definition information. As one example, the coordinate system setting unit 112 can compare a reference part (for example, a support part of a shelf edge or the like) between two coordinate systems (the coordinate system of the point cloud data and the coordinate system of the definition information) and compute a matrix for transforming a coordinate value in one coordinate system into a coordinate value in another coordinate system.

In the configuration of the present modified example, point cloud data are transformed in such a way that a coordinate system is the same between the point cloud data and definition information. Thereby, an effect of preventing positional misalignment upon setting a processing target area by using definition information can be expected.

### Second Example Embodiment

### <Functional Configuration Example>

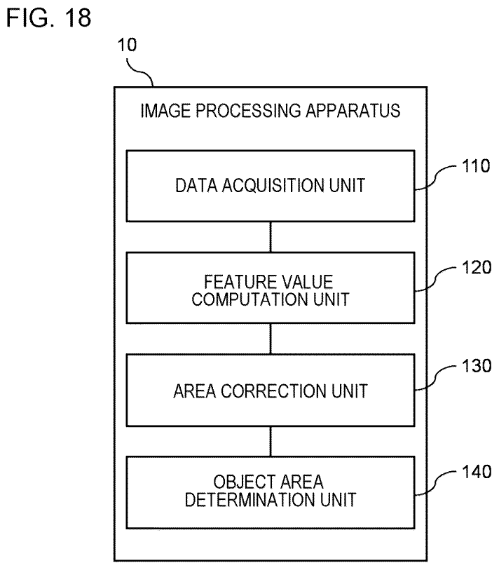

FIG. 18 is a diagram illustrating a third example of a functional configuration of the image processing apparatus according to the present disclosure. An image processing apparatus 10 illustrated in the present figure includes an object area determination unit 140 in addition to a data acquisition unit 110, a feature value computation unit 120, and an area correction unit 130.

The object area determination unit 140 determines an area where an object is present by processing a processing target area. The processing target area to be processed by the object area determination unit 140 includes a processing target area corrected by the area correction unit 130 as described in the first example embodiment.

### Operation Example

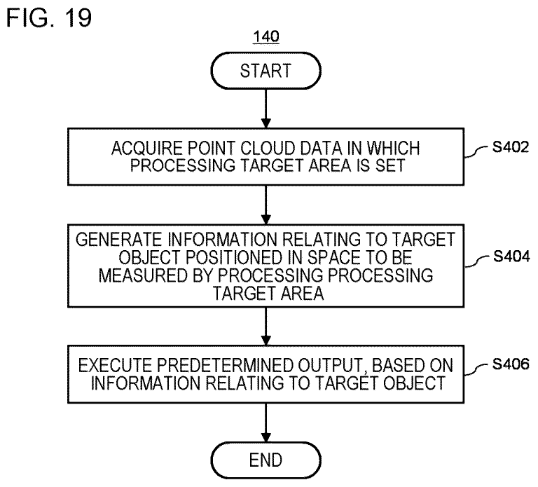

FIG. 19 is a flowchart illustrating a flow of processing executed by the object area determination unit 140 according to the present disclosure.

The object area determination unit 140 acquires point cloud data in which a processing target area is set (Step S402). As one example, the object area determination unit 140 acquires point cloud data 224 cut out as illustrated in FIG. 4 and information indicating a processing target area in the point cloud data 224. Herein, the processing target area set in the point cloud data 224 may have been corrected in a way as described by using FIGS. 10 to 16.

The object area determination unit 140 generates information relating to a target object positioned in a space to be measured by processing the processing target area set in the acquired point cloud data (Step S404). For example, the object area determination unit 140 identifies a position of a surface of a target object (a position where a target object is present), based on a point cloud in the processing target area. Then, the object area determination unit 140 computes a filling rate of the target object (a total volume or the like of the target object), based on the identified position of the surface of the target object. Specifically, according to the identified position of the surface of the target object, the object area determination unit 140 computes to which part of an area allocated for the target object the area is filled with the target object. Alternatively, the object area determination unit 140 may be configured to compute the number of target objects, based on the filling rate and a size of the individual target object.

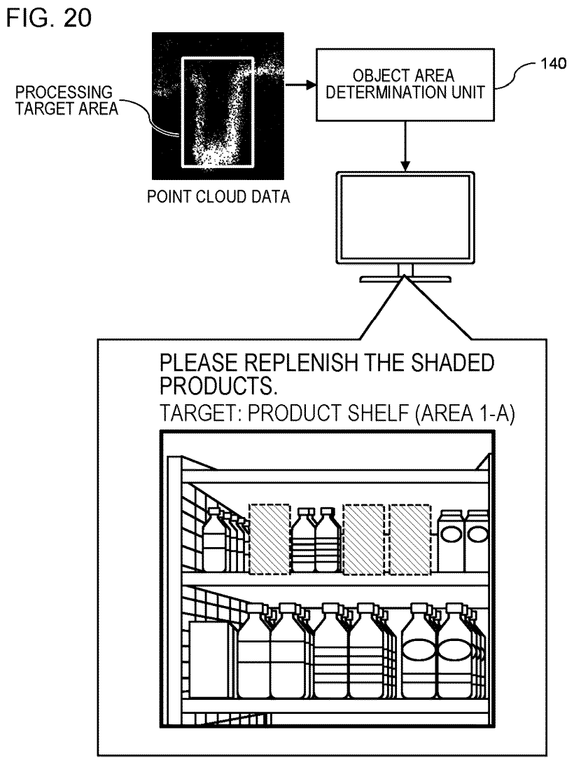

Then, the object area determination unit 140 performs predetermined output, based on the information generated in the processing in Step S404 (Step S406). As one example, the object area determination unit 140 determines whether the filling rate or the number of displayed target objects computed in the processing in Step S404 is equal to or less than a predetermined number, and outputs notification information (example: FIG. 20) encouraging replenishment of the target object according to a result of the determination.

FIG. 20 is a diagram illustrating one example of information output by the object area determination unit 140. In the example in FIG. 20, the object area determination unit 140 identifies a stockout state of each product on a product shelf in a retail store, and outputs notification information relating to stockout as appropriate. The configuration of notifying such information is expected to facilitate a management operation in a place where articles are managed, such as, for example, a product sales floor in a retail store or an inventory in a transportation warehouse. Further, point cloud data used by the object area determination unit 140 are corrected as appropriate by the area correction unit 130, as illustrated in the first example embodiment. This can improve precision of information as illustrated in FIG. 20.

While the present disclosure has been described above with reference to the example embodiments, the present disclosure is not limited to the above example embodiments. Various modifications that can be understood by a person skilled in the art may be applied to the configurations or details of the present disclosure within the scope of the present disclosure. Then, each example embodiment may be combined with another example embodiment as appropriate.

Further, while a plurality of steps (pieces of processing) are described in order in a plurality of flowcharts used in the above description, execution order of steps executed in each example embodiment is not limited to the described order. The order of the illustrated steps can be changed in each example embodiment, as long as the change does not detract from contents.

The whole or part of the above-described example embodiments can be described as, but not limited to, the following supplementary notes.

1. An image processing apparatus including:
a data acquisition unit that acquires point cloud data generated by scanning a space to be measured;
a feature value computation unit that sets a plurality of partial areas with a first boundary of a processing target area in the point cloud data as a reference, and computes a feature value for each of the plurality of partial areas; and
an area correction unit that corrects the processing target area by setting a new second boundary, based on a position of a partial area satisfying a reference relating to the feature value.

2. The image processing apparatus according to supplementary note 1, further including
an object determination unit that determines an area where an object is present by processing the processing target area.

3. The image processing apparatus according to supplementary note 1 or 2, in which
the feature value indicates a likeness of a surface of an object.

4. The image processing apparatus according to supplementary note 3, in which
the feature value includes at least one of a number of points and a density of points included in each partial area.

5. The image processing apparatus according to supplementary note 4, in which
the feature value computation unit sets the plurality of partial areas along a depth direction of the space, and
the area correction unit
   selects a first partial area with the first boundary as a reference,
   executes processing of searching for mutually adjoining two partial areas where a difference between the feature values is equal to or more than a reference value, in a first direction along the depth direction or in a second direction opposite from the first direction with the first partial area as a starting point, and,
   in a case where two partial areas where the difference is equal to or more than the reference value are found in the processing, sets the second boundary, based on a second partial area for which the feature value is greater between the two partial areas.

6. The image processing apparatus according to supplementary note 5, in which
the area correction unit
   sets the second boundary by moving the first boundary along any one of a plurality of sides configuring the second partial area extending in a direction crossing a depth direction of the space.

7. The image processing apparatus according to supplementary note 4, in which
the feature value computation unit sets the plurality of partial areas along a width direction of the space, and
the area correction unit
   selects a first partial area with the first boundary as a reference,
   executes processing of searching for mutually adjoining two partial areas where an absolute value of a difference between the feature values is equal to or more than a reference value, in a third direction along the width direction and in a fourth direction opposite from the third direction with the first partial area as a starting point, and
   sets the second boundary by moving the first boundary, based on a search result in the third direction and a search result in the fourth direction.

8. The image processing apparatus according to supplementary note 7, in which
the area correction unit
   determines, based on a combination of an increasing/decreasing trend of a feature value in the third direction and an increasing/decreasing trend of a feature value in the fourth direction, whether to set the second boundary, and in which of the third direction and the fourth direction the first boundary is to be moved in a case of setting the second boundary.

9. An image processing method including,
by a computer:
acquiring point cloud data generated by scanning a space to be measured;
setting a plurality of partial areas with a first boundary of a processing target area in the point cloud data as a reference, and computing a feature value for each of the plurality of partial areas; and
correcting the processing target area by setting a new second boundary, based on a position of a partial area satisfying a reference relating to the feature value.

10. A program for causing a computer to function as:
a data acquisition unit that acquires point cloud data generated by scanning a space to be measured;
a feature value computation unit that sets a plurality of partial areas with a first boundary of a processing target area in the point cloud data as a reference, and computes a feature value for each of the plurality of partial areas; and
an area correction unit that corrects the processing target area by setting a new second boundary, based on a position of a partial area satisfying a reference relating to the feature value.

Further, the whole or part of the configurations described in supplementary notes 2 to 8 that are dependent on the above-described supplementary note 1 (the image processing apparatus) can be also dependent on supplementary notes 9 (the image processing method) and 10 (the program) according to dependency similar to supplementary notes 2 to 8. Furthermore, without limitation to supplementary notes 1, 9, and 10, the whole or part of the configurations described as the supplementary notes can be also dependent similarly on various pieces of hardware, software, various kinds of recording means for storing software, or a system within the range not departing from the above-described example embodiments.

It is apparent that the present invention is not limited to the above embodiment, and may be modified and changed without departing from the scope and spirit of the invention.

[Reference Numerals]

| | |
|---|---|
| 10 | Image processing apparatus |
| 1000 | Computer |
| 1010 | Bus |
| 1020 | Processor |
| 1030 | Memory |
| 1040 | Storage device |
| 1050 | Input/output interface |
| 1060 | Network interface |
| 110 | Data acquisition unit |
| 112 | Coordinate system setting unit |
| 120 | Feature value computation unit |
| 130 | Area correction unit |
| 140 | Object area determination unit |
| 20 | Robot |
| 22 | Scanning apparatus |
| 222 | Point cloud data |
| 224 | Point cloud data |
| 30 | Space |
| 32 | Target object |
| 40 | Database |

What is claimed is:

1. An image processing apparatus comprising:
at least one memory configured to store instructions; and
at least one processor configured to execute the instructions to perform operations comprising:
acquiring point cloud data generated by scanning a space to be measured;
setting a plurality of partial areas with a first boundary of a processing target area in the point cloud data as a reference;
computing a feature value for each of the plurality of partial areas; and
correcting the processing target area by setting a new second boundary, based on a position of a partial area satisfying a reference relating to the feature value.

2. The image processing apparatus according to claim 1, further comprising
determining an area where an object is present by processing the processing target area.

3. The image processing apparatus according to claim 1, wherein
the feature value indicates a likeness of a surface of an object.

4. The image processing apparatus according to claim 3, wherein
the feature value includes at least one of a number of points and a density of points included in each partial area.

5. The image processing apparatus according to claim 4, wherein the operations further comprise:
setting the plurality of partial areas along a depth direction of the space;
selecting a first partial area with the first boundary as a reference;
executing processing of searching for mutually adjoining two partial areas where a difference between the feature values is equal to or more than a reference value, in a first direction along the depth direction or in a second direction opposite from the first direction with the first partial area as a starting point; and
in a case where two partial areas where the difference is equal to or more than the reference value are found in the processing, setting the second boundary, based on a second partial area for which the feature value is greater between the two partial areas.

6. The image processing apparatus according to claim 5, wherein
the operations further comprise setting the second boundary by moving the first boundary along any one of a plurality of sides configuring the second partial area extending in a direction crossing a depth direction of the space.

7. The image processing apparatus according to claim 4, wherein the operations further comprise:
setting the plurality of partial areas along a width direction of the space;
selecting a first partial area with the first boundary as a reference;
executing processing of searching for mutually adjoining two partial areas where an absolute value of a difference between the feature values is equal to or more than a reference value, in a third direction along the width direction and in a fourth direction opposite from the third direction with the first partial area as a starting point; and
setting the second boundary by moving the first boundary, based on a search result in the third direction and a search result in the fourth direction.

8. The image processing apparatus according to claim 7, wherein
the operations further comprise determining, based on a combination of an increasing/decreasing trend of a feature value in the third direction and an increasing/decreasing trend of a feature value in the fourth direction, whether to set the second boundary, and in which of the third direction and the fourth direction the first boundary is to be moved in a case of setting the second boundary.

9. An image processing method comprising,
by a computer:
acquiring point cloud data generated by scanning a space to be measured;
setting a plurality of partial areas with a first boundary of a processing target area in the point cloud data as a reference;
computing a feature value for each of the plurality of partial areas; and
correcting the processing target area by setting a new second boundary, based on a position of a partial area satisfying a reference relating to the feature value.

10. The image processing method according to claim 9, further comprising
determining an area where an object is present by processing the processing target area.

11. The image processing method according to claim 9, wherein
the feature value indicates a likeness of a surface of an object.

12. The image processing method according to claim 11, wherein
the feature value includes at least one of a number of points and a density of points included in each partial area.

13. The image processing method according to claim 12, further comprising:
setting the plurality of partial areas along a depth direction of the space;
selecting a first partial area with the first boundary as a reference;
executing processing of searching for mutually adjoining two partial areas where a difference between the feature values is equal to or more than a reference value, in a first direction along the depth direction or in a second direction opposite from the first direction with the first partial area as a starting point; and;
in a case where two partial areas where the difference is equal to or more than the reference value are found in the processing, setting the second boundary, based on a second partial area for which the feature value is greater between the two partial areas.

14. The image processing method according to claim 13, further comprising
setting the second boundary by moving the first boundary along any one of a plurality of sides configuring the second partial area extending in a direction crossing a depth direction of the space.

15. The image processing method according to claim 12, further comprising:
setting the plurality of partial areas along a width direction of the space;
selecting a first partial area with the first boundary as a reference;
executing processing of searching for mutually adjoining two partial areas where an absolute value of a difference between the feature values is equal to or more than a reference value, in a third direction along the width direction and in a fourth direction opposite from the third direction with the first partial area as a starting point; and
setting the second boundary by moving the first boundary, based on a search result in the third direction and a search result in the fourth direction.

16. The image processing method according to claim 15, further comprising
determining, based on a combination of an increasing/decreasing trend of a feature value in the third direction and an increasing/decreasing trend of a feature value in the fourth direction, whether to set the second boundary, and in which of the third direction and the fourth direction the first boundary is to be moved in a case of setting the second boundary.

17. A non-transitory computer-readable medium storing a program for causing a computer to perform operations comprising:
acquiring point cloud data generated by scanning a space to be measured;
setting a plurality of partial areas with a first boundary of a processing target area in the point cloud data as a reference;
computing a feature value for each of the plurality of partial areas; and
correcting the processing target area by setting a new second boundary, based on a position of a partial area satisfying a reference relating to the feature value.
